(19) United States
(12) Patent Application Publication
(10) Pub. No.: US 2018/0087641 A1
(43) Pub. Date: Mar. 29, 2018

(54) WASHER AND DIFFERENTIAL DEVICE

(71) Applicant: MUSASHI SEIMITSU INDUSTRY CO., LTD., TOYOHASHI-SHI (JP)

(72) Inventor: Hiroyuki MORI, TOYOHASHI-SHI (JP)

(21) Appl. No.: 15/703,419

(22) Filed: Sep. 13, 2017

(30) Foreign Application Priority Data
Sep. 27, 2016 (JP) 2016-188541

(51) Int. Cl. F16H 48/38; F16H 48/08

(52) U.S. Cl. CPC F16H 48/38; F16H 2048/387; F16H 48/08

(57) ABSTRACT

A washer includes at least one differential gear back face part covering a back face of one differential gear, an output gear back face part covering a back face of one output gear, and at least one linking part connecting between the output gear back face part and the differential gear back face part. A guideway extending from an outer peripheral part of the output gear back face part up to the differential gear back face part is formed in an inner face of the linking part, the guideway including a step separating a middle part of the linking part from both end parts of the linking part.

### BACKGROUND OF THE INVENTION

### Field of the Invention

The present invention relates to a differential device mounted on a vehicle and to a washer that can be used in a differential device, a transmission device and the like.

### Description of the Related Art

A differential device with a structure in which four washers are integrally linked has already been disclosed (e.g. Japanese Utility Model Application KOKAI No. 5-59019, Japanese Patent No. 4304068, German Patent Application Laid-open No. 19730004). Furthermore, a technique of forming as a unit two washers formed into a spectacles shape has already been disclosed, although it is a planetary gear (e.g. Japanese Patent No. 4857465).

However, in a washer structure in which a washer applied to a side gear side and a washer applied to a pinion gear side are integrated using a linking part, as in Japanese Utility Model Application KOKAI No. 5-59019, Japanese Patent No. 4304068, German Patent Application Laid-open No. 19730004, and Japanese Patent No. 4857465, there is only a limited amount of lubricating oil flowing from a back face of the side gear to a back face of the pinion gear. Because of this, there is a possibility that the washer and the pinion gear will seize up. In particular, when a washer is made of a resin, there is a possibility that the washer made of a resin will be melted by frictional heating due to rotation of the pinion gear.

### SUMMARY OF THE INVENTION

An object of the present invention is to provide a washer and a differential device that can reduce effectively seizure between a pinion gear and the washer.

In order to achieve the object, a washer according to one embodiment of the present invention comprises at least one differential gear back face part covering a back face of one differential gear, an output gear back face part covering a back face of one output gear, and at least one linking part connecting between the output gear back face part and the differential gear back face part, wherein a guideway extending from an outer peripheral part of the output gear back face part up to the differential gear back face part is formed in an inner face of the linking part, the guideway including a step separating a middle part of the linking part from both end parts of the linking part.

In order to achieve the object, a differential device according to one embodiment of the present invention comprises an input member, a plurality of differential gears housed within the input member, a pair of output gears housed within the input member and meshing with the plurality of differential gears, and a plurality of the washers, described above, housed within the input member.

In accordance with the present invention, it is possible, by utilizing the centrifugal force of the rotating output gear, to efficiently feed lubricating oil present on the back face side of the output gear toward the back face side of the differential gear, thus improving the resistance to seizure in the differential gear.

The above and other objects, characteristics and advantages of the present invention will be clear from detailed descriptions of the preferred embodiments which will be provided below while referring to the attached drawings.

### BRIEF DESCRIPTION OF THE DRAWINGS

FIG. 1 is a sectional view schematically showing the overall arrangement of a differential device related to one embodiment of the present invention.

FIG. 2 is an enlarged sectional view showing the relationship of a washer to a pinion gear and a side gear.

FIGS. 3A and 3B are enlarged perspective views of a washer related to a first embodiment.

FIGS. 4A and 4B are enlarged perspective views of a washer related to a second embodiment.

FIGS. 5A and 5B are enlarged perspective views of a washer related to a third embodiment.

FIG. 6 is an enlarged perspective view of a washer related to a fourth embodiment.

FIG. 7 is an enlarged perspective view of a washer related to a fifth embodiment.

### DESCRIPTION OF THE PREFERRED EMBODIMENTS

Embodiments of the present invention are explained below by reference to the attached drawings.

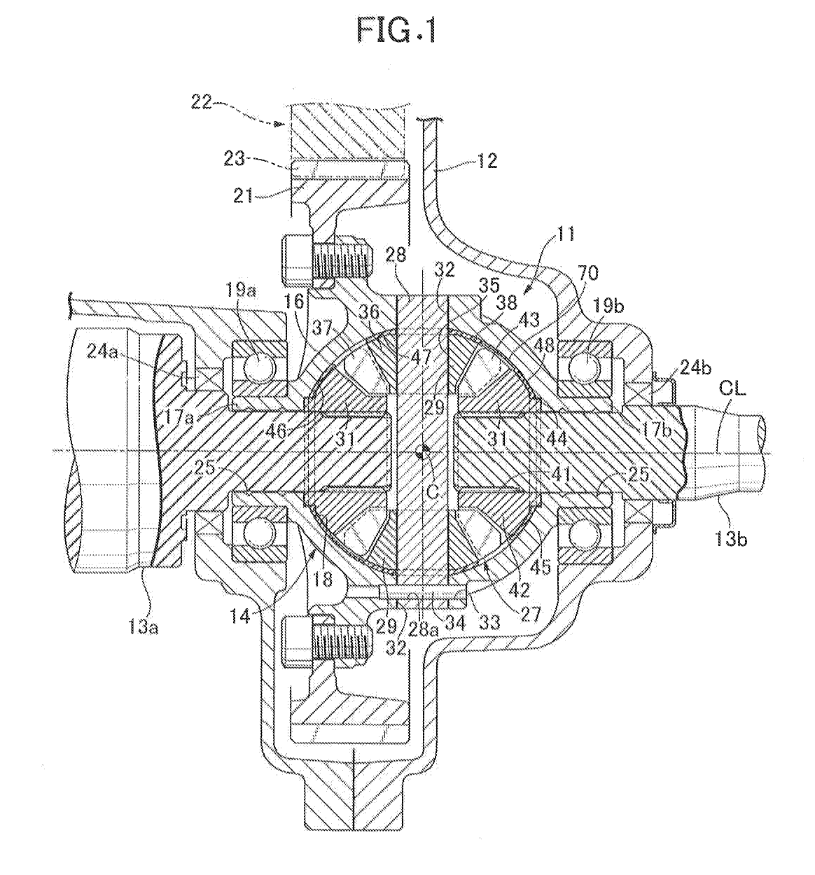

FIG. 1 schematically shows the overall arrangement of a differential device 11 related to one embodiment of the present invention. An automobile includes a transmission case 12 that is disposed next to for example an engine (not illustrated) as a power source mounted on the automobile and houses a transmission (not illustrated) and the differential device 11. For example, a pair of left and right output shafts 13a and 13b connected to axles are supported on the transmission case 12 so as to be rotatable around a central axis CL. The two output shafts 13a and 13b are disposed coaxially to each other and each have one end joined to the differential device 11 within the transmission case 12.

The differential device 11 includes for example a differential case 14 supported on the transmission case 12 so as to be rotatable around the central axis (rotational axis) CL, and a differential gear mechanism 27 as a differential mechanism housed within the differential case 14. The differential case (input member) 14 includes for example a spherical part 16, a first bearing portion (first boss part) 17a and a second bearing portion (second boss part) 17b formed integrally with the spherical part 16 and projecting in opposite directions from each other on the central axis CL, and a spherical space 18 defined by the spherical part 16 and having a center C on the central axis CL.

Furthermore, the first bearing portion 17a and the second bearing portion 17b are formed into for example a cylindrical shape coaxial with the central axis CL. Moreover, the first bearing portion 17a and the second bearing portion 17b are, for example, fitted via their outer peripheral faces in bearings 19a and 19b respectively. The output shafts 13a and 13b are inserted into the first bearing portion 17a and the second bearing portion 17b respectively.

Connected to the differential case 14 is for example a ring gear 21. The ring gear 21 has a large number of gear teeth disposed as for example a ring shape coaxial with the central axis CL. The ring gear 21 meshes with a gear part 23 of a reduction gear mechanism 22. Power of the engine is thereby transmitted from the transmission to the ring gear 21.

Disposed between the transmission case 12 and the output shafts 13a and 13b are for example seal members 24a and 24b having an annular shape. The seal members 24a and 24b provide a liquid-tight seal between the transmission case 12 and the rotating output shafts 13a and 13b. Furthermore, formed in a bottom part of the transmission case 12 is an oil pan (not illustrated) that faces an internal space of the transmission case 12 and stores a predetermined amount of lubricating oil. Lubricating oil stored in the oil pan is scooped up and scattered around by rotation of the differential case 14 or a movable element of the reduction gear mechanism 22 in the internal space of the transmission case 12. In this way, mechanical moving parts present inside and outside the differential case 14 are lubricated with the scattered lubricating oil.

Furthermore, bored in the spherical part 16 is for example a support hole 32 having a cylindrical shape and an axis passing through the center C and orthogonal to the central axis CL. The support hole 32 extends through the spherical part 16 from the inside to the outside. Moreover, formed in the spherical part 16 is a pin hole 33 traversing one end part of the support hole 32 parallel to the central axis CL and extending through the spherical part 16.

Furthermore, for example, a lubrication groove 25 having a helical shape is formed in inner peripheral faces of the first bearing portion 17a and the second bearing portion 17b. Therefore, while the output shafts 13a and 13b are rotating, lubricating oil that makes contact with the output shafts 13a and 13b outside the differential case 14 is guided to the spherical space 18 along the lubrication groove 25.

Moreover, a differential gear mechanism 27 includes, for example, a pinion shaft (shaft) 28, supported on the differential case 14, having an axis passing through the center C while intersecting the central axis CL at right angles, a plurality (two in this embodiment) of pinion gears (differential gears) 29 supported on the pinion shaft 28 so as to be rotatable around the axis of the pinion shaft 28, and a pair of side gears (output gears) 31, supported so as to be rotatable around the central axis CL, meshing with the plurality of pinion gears 29.

Furthermore, both ends of the pinion shaft 28 are each fitted into for example the spherical part 16. That is, the pinion shaft 28 is inserted into the support hole 32. Moreover, formed in the pinion shaft 28 is for example a through hole 28a that has an identical diameter to and is coaxial with the pin hole 33 in a state in which the pinion shaft 28 is fitted into the spherical part 16. For example, a pin 34 is press fitted into the pin hole 33 and the through hole 28a. The pinion shaft 28 is thereby prevented from falling out of the differential case 14.

Each of the pinion gears 29 includes for example a support body 36 having a shaft hole 35 through which the pinion shaft 28 rotatably passes, and a plurality of gear teeth 37 projecting from the support body 36 outward in the radial direction of the support body 36. The gear teeth 37 are arranged for example in a ring shape around the axis of the pinion shaft 28. A slide face 38 is defined on a back face of the support body 36, the slide face 38 extending from the outer edge, in the axial direction, of the shaft hole 35 radially outward and being received by the spherical part 16. The slide face 38 is formed into for example a symmetrical shape with respect to the axis of the pinion shaft 28 as a reference. In this embodiment, the slide face 38 is formed from for example a partially spherical surface having the center C.

Furthermore, in this embodiment, the pinion shaft 28 and the pinion gear 29 are separate bodies from each other, but the present invention is not limited thereto. The present invention may have an arrangement in which for example the pinion gear and the pinion shaft are united. Therefore, the pinion gear 29 is supported on the differential case 14 (more specifically, it is supported on the differential case 14 via the pinion shaft 28). Furthermore, the pinion gear 29 can spin with respect to the differential case 14 and can revolve around the center of rotation of the differential case 14.

Each of the side gears 31 includes for example a support body 42 having a shaft hole 41 that receives extremities of the output shafts 13a and 13b, a plurality of gear teeth 43 projecting from the support body 42 outward in the radial direction of the support body 42 and meshing with the gear teeth 37 of the pinion gear 29, and a boss 44 projecting from a back face of the support body 42 while surrounding the shaft hole 41. The output shafts 13a and 13b are spline joined to the corresponding shaft hole 41.

Furthermore, the output shafts 13a and 13b are relatively non-rotatably fitted into the corresponding side gear 31. When the differential device 11 undergoes differential motion, the rotational torque of the side gear 31 is transmitted to the output shafts 13a and 13b via the spline, thus making the side gear 31 and the output shaft 13a and 13b corresponding to the side gear 31 rotate as a unit. The gear teeth 43 are arranged as a ring shape around the central axis CL.

Defined on the back face of the support body 42 is for example a slide face 45 extending from the peripheral edge of the boss 44 outward in the radial direction of the support body 42 and received by the spherical part 16. The slide face 45 is formed into for example a symmetrical shape with respect to the central axis CL as a reference. In this embodiment, the slide face 45 is formed from for example a partially spherical surface having the center C.

Formed on an inside face of the spherical part 16 is for example a side gear receiving face (output gear receiving face) 46 receiving the slide face 45 of the side gear 31 around the output shafts 13a and 13b. The side gear receiving face 46 is formed as a symmetrical shape with respect to the central axis CL as a reference. Therefore, the differential case 14 can support a back face of the side gear 31 slidably around the central axis CL. Moreover, the side gear receiving face 46 may be defined by a partially spherical surface having the center C. Furthermore, the shape of the side gear receiving face 46 may correspond to the shape of the slide face 45 of the side gear 31.

Furthermore, formed on the inside face of the spherical part 16 is for example a pinion gear receiving face (differential gear receiving face) 47 receiving the slide face 38 of the pinion gear 29 around the pinion shaft 28. The pinion gear receiving face 47 is formed as a symmetrical shape with respect to the axis of the pinion shaft 28 as a reference. Therefore, the differential case 14 can support a back face of the pinion gear 29 slidably around the axis of the pinion shaft 28. Moreover, the pinion gear receiving face 47 may be defined as a partially spherical surface having the center C. Furthermore, the shape of the pinion gear receiving face 47 may correspond to the shape of the slide face 38 of the pinion gear 29.

For example, one washer 48 is disposed in common between the inside face of the spherical part 16 and the back face of one pinion gear 29 and the back face of one side gear 31. The washer 48 is molded using for example a resin material.

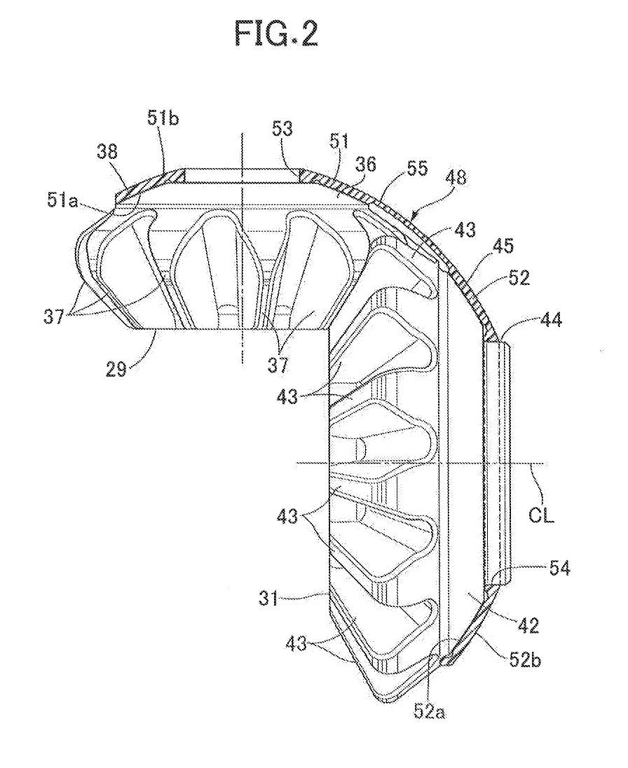

As shown in FIG. 2, the washer 48 includes for example a pinion gear back face part (differential gear back face part) 51 covering the back face of one pinion gear 29, a side gear back face part (output gear back face part) 52 covering the back face of one side gear 31, and a linking part 55 connecting between the side gear back face part 52 and the pinion gear back face part 51.

The pinion gear back face part 51 includes for example a front contact face 51a making contact with a face with the slide face 38 of the pinion gear 29, and a reverse contact face 51b, on the reverse side of the front contact face 51a, making contact with a face with the pinion gear receiving face 47 of the differential case 14. The front contact face 51a is formed from for example a partially spherical surface conforming to the slide face 38. For example, a through hole 53 is bored in the center of the front contact face 51a. The pinion shaft 28 is inserted into the through hole 53.

The reverse contact face 51b is formed from for example a partially spherical surface conforming to the pinion gear receiving face 47. The reverse contact face 51b extends outward in the radial direction of the pinion gear 29 from the edge of the through hole 53.

The side gear back face part 52 includes for example a front contact face 52a making contact with a face with the slide face 45 of the side gear 31, and a reverse contact face 52b, on the reverse side of the front contact face 52a, making contact with a face with the side gear receiving face 46. The front contact face 52a is formed from a partially spherical surface conforming to the slide face 45. A through hole 54 is bored in the center of the front contact face 52a. The boss 44 of the side gear 31 is inserted into the through hole 54.

The reverse contact face 52b is formed from a partially spherical surface conforming to the side gear receiving face 46. The reverse contact face 52b extends outward in the radial direction of the side gear 31 from the edge of the through hole 54.

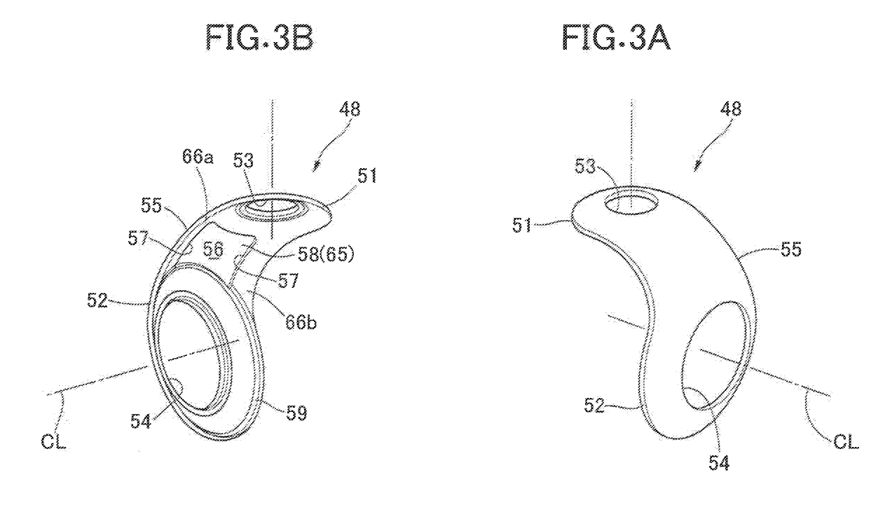

Furthermore, formed on an inner face of the linking part 55 is, as shown in for example FIG. 3B, a step 57 separating a middle part 65 of the linking part 55 from both end parts 66a and 66b of the linking part 55. The step 57 extends from an outer peripheral part of the side gear back face part 52 up to the pinion gear back face part 51. Moreover, formed on the middle part 65 separated by the step 57 is a middle part face (bottom face of recess part, bottom face of first recess part) 58. The thickness of the linking part 55 at the middle part face 58 is smaller than the thickness of the linking part 55 at the both end parts 66a and 66b. Because of this, a guideway 56 as a recess part is formed from the step 57 and the middle part face 58. In this arrangement, the step 57 forms a side face of the recess part, and the middle part face 58 forms the bottom face of the recess part. The middle part face 58 is formed from for example an inclined face in which the step 57 increases in size in going away from the rotational axis of the side gear 31 (in going closer to the pinion gear 29 from the rotational axis of the side gear 31). That is, the step 57 increases in size (increases in depth) in going away from for example the rotational axis of the side gear 31.

Formed in an outer peripheral part of the front contact face 52a of the side gear back face part 52 is an indented part 59 that is recessed with respect to a curved face curving toward the outer peripheral side from the inner peripheral side of the side gear 31. The indented part 59 is formed from for example a groove formed into an annular shape along the outer peripheral part of the front contact face 52a. Furthermore, the side gear back face part 52 forms a partially spherical surface coaxial with the front contact face 52a outside the indented part 59. Because of this, the outside of the indented part 59 is blocked by the slide face 45 of the side gear 31. The indented part 59 therefore forms a passage for lubricating oil along the outer periphery of the front contact face 52a. Moreover, the guideway 56 is formed by joining the indented part 59 and the pinion gear back face part 51.

The operation of this embodiment is now explained. Power of the engine is transmitted from the reduction gear mechanism 22 to the ring gear 21, thus causing the differential case 14 to rotate around the central axis CL. When the automobile is travelling straight ahead, since no difference in rotational speed between the left and right wheels occurs, the pinion gear 29 revolves around the central axis CL together with the differential case 14 without spinning around the pinion shaft 28. The left and right side gears 31 are rotated at the same speed by revolution of the pinion gear 29. Because of this, the driving force of the side gear 31 is transmitted evenly to the left and right output shafts 13a and 13b.

On the other hand, when the automobile is turning, etc., and a difference in rotational speed between the left and right wheels occurs, the pinion gear 29 revolves while spinning. Therefore, a rotational driving force is transmitted from the pinion gear 29 to the left and right side gears 31 while allowing differential rotation thereof.

In this process, the slide face 45 of the side gear 31 is slidably received by the inner face of the differential case 14 via the side gear receiving face 46. Furthermore, the slide face 38 of the pinion gear 29 is slidably received by the inner face of the differential case 14 via the pinion gear receiving face 47. The washer 48 contributes to a reduction in the contact resistance between the differential case 14 and the side gear 31 and pinion gear 29.

While the output shafts 13a and 13b are rotating, lubricating oil is supplied to the differential gear mechanism 27 from an oil pan within the transmission case 12. With regard to the output shafts 13a and 13b, lubricating oil is introduced into the differential case 14 from the outside of the differential case 14 via the lubrication groove 25 of the first bearing portion 17a and the second bearing portion 17b. Part of the lubricating oil thus introduced is guided to the front contact face 52a via the through hole 54. The lubricating oil thus guided is guided outward in the radial direction of the side gear 31 between the side gear 31 and the washer 48 by virtue of the centrifugal force due to rotation of the side gear 31. The lubricating oil thus guided is further guided to the guideway 56 via the indented part 59 by virtue of the centrifugal force due to rotation of the side gear 31. Furthermore, the lubricating oil guided to the guideway 56 is further guided in between the front contact face 51a of the pinion gear back face part 51 and the slide face 38 of the pinion gear 29 by virtue of the centrifugal force due to rotation of the side gear 31.

In accordance with the present embodiment, the guideway 56 extending from the outer peripheral part of the side gear back face part 52 up to the pinion gear back face part 51 is formed on the inner side of the linking part 55 of the washer 48, and the guideway 56 includes the step 57 separating the middle part 65 of the linking part 55 from the both end parts 66a and 66b of the linking part 55. Because of this, lubricating oil present on the back face side of the side gear 31 can be fed efficiently to the back face side of the pinion gear 29 by utilizing the centrifugal force of the rotating side gear 31. This improves the resistance to seizure of the pinion gear 29.

Furthermore, in accordance with the present embodiment, the step 57 increases in size in going away from the rotational axis (central axis CL) of the side gear 31 (in going from the rotational axis of the side gear 31 toward the pinion gear back face part 51). Because of this, in response to the centrifugal force of the side gear 31 rotating around the rotational axis, lubricating oil present on the back face side of the side gear 31 can be fed to the back face part of the pinion gear 29 more efficiently.

Moreover, in the present embodiment, the indented part 59 recessed with respect to the curved face curving from the inner peripheral side of the side gear 31 toward the outer peripheral side thereof is formed in the outer peripheral part of the inner face of the side gear back face part 52, and the guideway 56 is formed so as to join the indented part 59 and the pinion gear back face part 51. Therefore, lubricating oil traveling on the back face of the side gear 31 is collected by the indented part 59 in the outer peripheral part of the side gear back face part 52, and is supplied from the indented part 59 to the back face of the pinion gear 29 along the guideway 56. In this way, a sufficient amount of lubricating oil can be fed to the pinion gear 29. Furthermore, due to the indented part 59 being formed, it is possible to avoid contact between the washer 48 and the outer peripheral part of the side gear 31 where a load is concentrated due to the centrifugal force of the side gear 31.

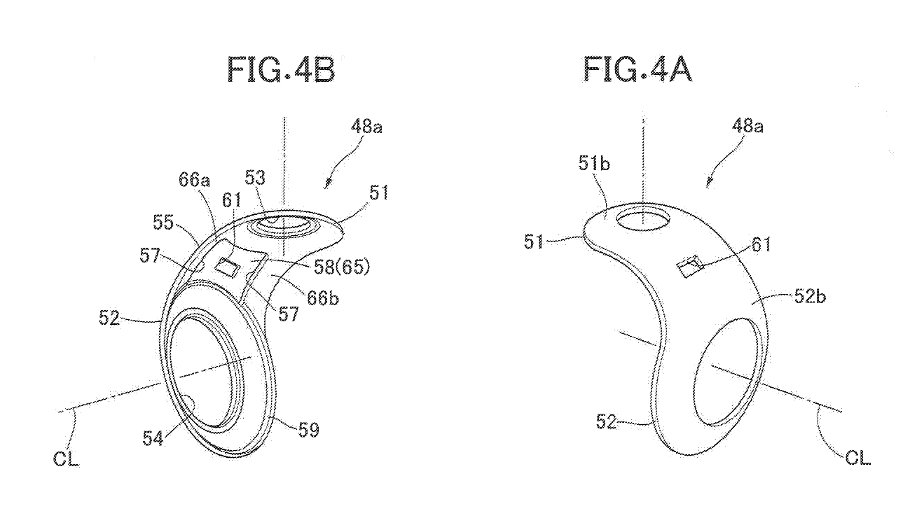

FIGS. 4A and 4B schematically show the arrangement of a washer 48a related to a second embodiment. The second embodiment is different from the first embodiment in terms of the washer 48a having an opening 61 extending through an inner face and an outer face of the linking part 55 in at least part of the middle part face 58 of the guideway 56 (a middle part of the middle part face 58 of the guideway 56 in the second embodiment) and in terms of a linking part opposing face 70 being formed on the face, opposing the linking part 55, of the differential case 14. The arrangement of the second embodiment is otherwise the same as that of the first embodiment. Because of this, only differences from the first embodiment are explained here, and parts of the arrangement that are the same as those of the first embodiment are to be referred to in the first embodiment and are not explained in detail.

The washer 48a includes the opening 61 extending through the inner face and the outer face of the linking part 55 in at least part of the middle part face 58 of the guideway 56 (the middle part of the middle part face 58 of the guideway 56 in the second embodiment). Furthermore, the outer face of the linking part 55 has a shape conforming to the inner face of the differential case 14. For example, the outer face of the linking part 55 is formed as a partially spherical surface that continues from the reverse contact face 52b of the side gear back face part 52 and the reverse contact face 51b of the pinion gear back face part 51. Moreover, the linking part opposing face 70 of the differential case 14 is formed so as to oppose the outer face of the linking part 55.

Because of this, the recess part can also be formed from the opening 61 and the linking part opposing face 70. That is, in the guideway 56 of the second embodiment, a recess part having two steps may be formed from a recess part formed from the step 57 and the middle part face 58 as a first recess part and a recess part formed from the opening 61 and the linking part opposing face 70 of the differential case 14 as a second recess part.

The operation of the second embodiment is now explained. The operation of the second embodiment has the following operation in addition to the operation of the first embodiment. In response to the centrifugal force due to rotation of the side gear 31, lubricating oil that has flowed between the back face of the washer 48 and the side gear receiving face (slide face) 46 of the differential case 14 (other housing) is guided from the opening 61 to the guideway 56 in the inner face of the washer 48a.

In accordance with the second embodiment, in addition to the effects of the first embodiment, it is also possible to utilize lubricating oil that has flowed on the outer face of the washer 48a, for lubrication of the back face side of the pinion gear 29.

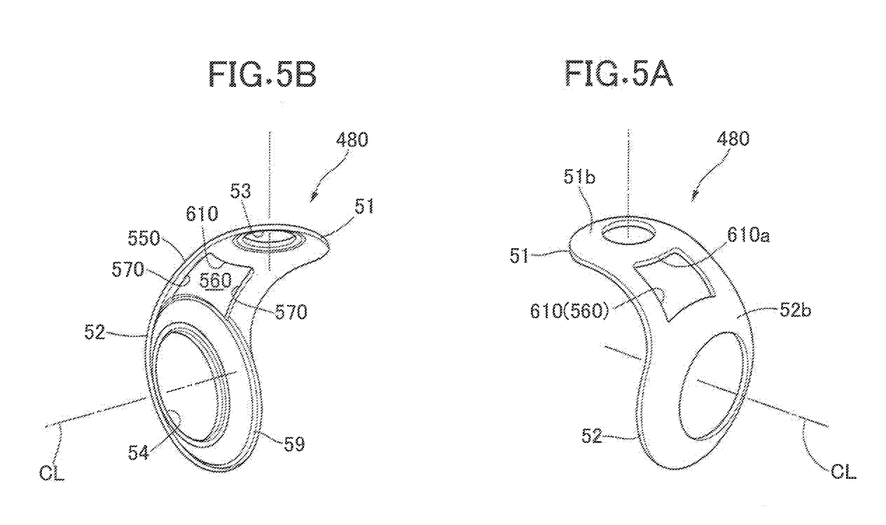

FIGS. 5A and 5B schematically show the arrangement of a washer 480 related to a third embodiment. The third embodiment has an arrangement in which the opening 61 of the second embodiment is widened over the entirety of the middle part face 58 of the guideway 56. The arrangement of the third embodiment is otherwise the same as that of the first embodiment. Because of this, only differences from the first embodiment are explained here, and parts of the arrangement that are the same as those of the first embodiment are to be referred to in the first embodiment and are not explained in detail.

A linking part 550 of the washer 480 includes a step 570 forming a region for a guideway 560, and an opening 610 defined by the step 570 and extending through an inner face and an outer face of the linking part 550. Furthermore, the outer face of the linking part 550 has a shape conforming to the inner face of the differential case 14. For example, the outer face of the linking part 550 is formed from a partially spherical surface that continues from the reverse contact face 52b of the side gear back face part 52 and the reverse contact face 51b of the pinion gear back face part 51. Furthermore, a linking part opposing face 700 of the differential case 14 is formed so as to oppose the outer face of the linking part 550. Because of this, a recess part can be formed from the opening 610 and the linking part opposing face 700.

The operation of the third embodiment is now explained. In response to the centrifugal force due to rotation of the side gear 31, lubricating oil that has flowed between the back face of the washer 480 and the side gear receiving face (slide face) 46 of the differential case 14 (other housing) is guided from the opening 610 to the inner face of the washer 480.

In accordance with the third embodiment, in addition to the effects of the first embodiment, lubricating oil that has flowed on the outer face of the washer 480 can be utilized for lubrication of the back face side of the pinion gear 29.

Furthermore, the side face (opening side face) 61a of the opening 61 of the second embodiment and the side face (opening side face) 610a of the opening 610 of the third embodiment may be inclined. More specifically, the side face (opening side face) 61a of the opening 61 of the second embodiment and the side face (opening side face) 610a of the opening 610 of the third embodiment may be formed as a face that goes away from the inner face of the differential case 14 in going away from the side gear back face part 52. In accordance with such an inclined face, lubricating oil that has flowed on the inner face of the differential case 14 from the side gear back face part 52 can easily flow into the inner side of the pinion gear back face part 51. This enables a larger amount of lubricating oil to be supplied to the pinion gear 29.

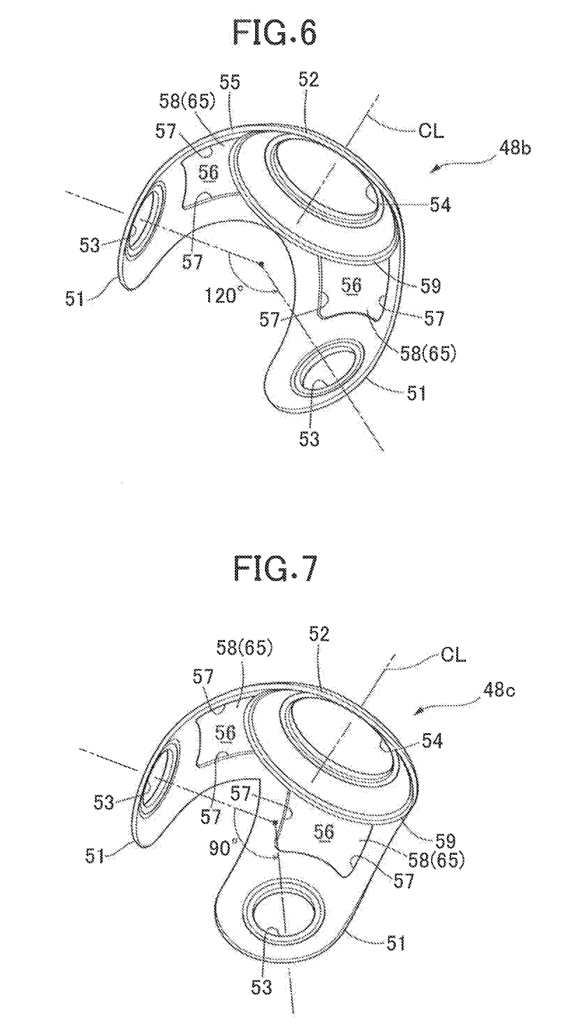

FIG. 6 schematically shows the arrangement of a washer 48b related to a fourth embodiment. The washer of the fourth embodiment is different from that of the first embodiment in terms of having a plurality (two in the fourth embodiment) of pinion gear back face parts per side gear back face part. The arrangement of the fourth embodiment is otherwise the same as that of the first embodiment. Because of this, only differences from the first embodiment are explained here, and parts of the arrangement that are the same as those of the first embodiment are to be referred to in the first embodiment and are not explained in detail.

The washer 48b includes a plurality (two in the fourth embodiment) of pinion gear back face parts 51 per side gear back face part 52. Each of the pinion gear back face parts 51 covers the back face of one pinion gear 29. Each of the pinion gear back face parts 51 is individually connected to the side gear back face part 52 by means of the linking part 55. As described above, the step 57 partitioning the guideway 56 is formed on the inner face of the linking part 55. For example, the plurality (two in the fourth embodiment) of through holes 53 have axes intersecting each other at a central angle of 120° around the central axis CL.

Therefore, such a washer 48b may be applied to a differential gear mechanism in which three pinion gears 29 are disposed around the central axis CL at equal intervals of 120° . In this arrangement, the two pinion gear back face parts 51 of the washer 48b cover the back faces of two pinion gears 29 among the three pinion gears 29, and the back face of the remaining one pinion gear 29 may be covered with the pinion gear back face part 51, described above, of each of the washers 48, 48a, and 480.

Furthermore, the opening 61 may be formed in the guideway 56 of the washer 48b of the fourth embodiment as in the second embodiment or the third embodiment. That is, the fourth embodiment may be applied not only to the arrangement of the first embodiment but also to that of the second embodiment and the third embodiment. Because of this, the effects of the fourth embodiment are the same as the effects of the first to third embodiments to which the fourth embodiment is applied. Therefore, the effects of the fourth embodiment are to be referred to in the effects of the first to third embodiments and are not explained in detail.

FIG. 7 schematically shows the arrangement of a washer 48c related to a fifth embodiment. The washer of the fifth embodiment is a modified example of the fourth embodiment. Because of this, in the fifth embodiment, differences from the fourth embodiment are explained; a detailed explanation is to be referred to in the fourth embodiment and is omitted here.

The washer 48c has a plurality (two in the fifth embodiment) of pinion gear back face parts 51 per side gear back face part 52. Furthermore, the plurality (two in the fifth embodiment) of through holes 53 have axes intersecting each other at a central angle of 90° around the central axis CL. Therefore, such a washer 48c may be applied to a differential gear mechanism in which four pinion gears 29 are disposed around the central axis CL at equal intervals of 90°.

Furthermore, the effects of the fifth embodiment are basically the same as the effects of the fourth embodiment. Because of this, the effects of the fifth embodiment are to be referred to in the fourth embodiment and will not be explained in detail.

Moreover, the present invention may be applied not only to a washer having one pinion gear back face part per side gear back face part as in the first to third embodiments, but also to a washer having a plurality of pinion gear back face parts per side gear back face part as in the fourth and fifth embodiments. Furthermore, in this arrangement, depending on the embodiment, the number of pinion gear back face parts and the number of linking parts may be set appropriately according to the number of pinion gears, such as three or four instead of two as for the number of pinion gear back face parts in the fourth and fifth embodiments.

Moreover, in the above embodiments, a differential device equipped with a washer is illustrated, but the present invention is not limited thereto. The present invention may be applied to for example a transmission device equipped with a washer. Furthermore, in the above embodiments, the washer is molded using a resin material, but the present invention is not limited thereto. In the present invention, as a material for molding the washer, for example, a composite material in which a reinforcing material is mixed with a metal or resin material may be employed. Examples of the reinforcing material include metal, glass fiber, carbon fiber, aramid fiber, and boron fiber.

In addition, the step 57 may be formed only on the downstream side in the rotational direction of the output shafts 13a and 13b when the automobile is traveling forward. Such a step 57 can hold back lubricating oil within the linking part 55 when the side gear 31 is rotating. This makes it possible to ensure that a sufficient amount of lubricating oil is supplied to the pinion gear 29.

What is claimed is:

1. A washer comprising
at least one differential gear back face part covering a back face of one differential gear,
an output gear back face part covering a back face of one output gear, and
at least one linking part connecting between the output gear back face part and the differential gear back face part,
wherein a guideway extending from an outer peripheral part of the output gear back face part up to the differential gear back face part is formed in an inner face of the linking part, the guideway including a step separating a middle part of the linking part from both end parts of the linking part.

2. The washer according to claim 1, wherein the step increases in size in going away from a rotational axis of the output gear.

3. The washer according to claim 1, wherein an indented part recessed inward with respect to a curved face curving from an inner peripheral side toward an outer peripheral side of the output gear is formed in an outer peripheral part of an inner face of the output gear back face part, and
the guideway is formed so as to join the indented part and the differential gear back face part.

4. The washer according to claim 2, wherein an indented part recessed inward with respect to a curved face curving from an inner peripheral side toward an outer peripheral side of the output gear is formed in an outer peripheral part of an inner face of the output gear back face part, and
the guideway is formed so as to join the indented part and the differential gear back face part.

5. The washer according to claim 1, wherein the guideway includes an opening extending through the inner face and an outer face of the linking part.

6. The washer according to claim 2, wherein the guideway includes an opening extending through the inner face and an outer face of the linking part.

7. The washer according to claim 3, wherein the guideway includes an opening extending through the inner face and an outer face of the linking part.

8. The washer according to claim 4, wherein the guideway includes an opening extending through the inner face and an outer face of the linking part.

9. A differential device comprising
an input member,
a plurality of differential gears housed within the input member,
a pair of output gears housed within the input member and meshing with the plurality of differential gears, and
a plurality of the washers according to claim 1 housed within the input member.

10. A differential device comprising
an input member,
a plurality of differential gears housed within the input member,
a pair of output gears housed within the input member and meshing with the plurality of differential gears, and
a plurality of the washers according to claim 2 housed within the input member.

11. A differential device comprising
an input member,
a plurality of differential gears housed within the input member,
a pair of output gears housed within the input member and meshing with the plurality of differential gears, and
a plurality of the washers according to claim 3 housed within the input member.

12. A differential device comprising
an input member,
a plurality of differential gears housed within the input member,
a pair of output gears housed within the input member and meshing with the plurality of differential gears, and
a plurality of the washers according to claim 4 housed within the input member.

13. A differential device comprising
an input member,
a plurality of differential gears housed within the input member,
a pair of output gears housed within the input member and meshing with the plurality of differential gears, and
a plurality of the washers according to claim 5 housed within the input member.

14. A differential device comprising
an input member,
a plurality of differential gears housed within the input member,
a pair of output gears housed within the input member and meshing with the plurality of differential gears, and
a plurality of the washers according to claim 6 housed within the input member.

15. A differential device comprising
an input member,
a plurality of differential gears housed within the input member,
a pair of output gears housed within the input member and meshing with the plurality of differential gears, and
a plurality of the washers according to claim 7 housed within the input member.

16. A differential device comprising
an input member,
a plurality of differential gears housed within the input member,
a pair of output gears housed within the input member and meshing with the plurality of differential gears, and
a plurality of the washers according to claim 8 housed within the input member.
